(19) United States
(12) Patent Application Publication
(10) Pub. No.: US 2026/0098431 A1
(43) Pub. Date: Apr. 9, 2026

(54) MOTOR VEHICLE LOCK

(71) Applicant: Brose Schließsysteme GmbH & Co. Kommanditgesellschaft, Wuppertal (DE)

(72) Inventors: Roman JOSCHKO, Dormagen (DE); Andreas HOFFMANN, Voerde (DE); Ludger GRAUTE, Essen (DE); Nils BIERMANN, Wuppertal (DE); Benedikt CHADARAVICIUS, Wuppertal (DE)

(21) Appl. No.: 19/352,056

(22) Filed: Oct. 7, 2025

(30) Foreign Application Priority Data
Oct. 8, 2024 (DE) 102024128990.2

(51) Int. Cl. E05B 81/16; E05B 81/46; E05B 81/76

(52) U.S. Cl. CPC E05B 81/16; E05B 81/46; E05B 81/76

(57) ABSTRACT

The invention relates to a motor vehicle lock with a lock latch and at least one pawl for locking the lock latch, wherein the pawl is assigned a release lever, wherein an opening drive adjusts the release lever to the release position for lifting the pawl and subsequently returns the release lever to the initial position, wherein an actuating lever can be mechanically coupled to the release lever via a clutch arrangement, wherein the clutch arrangement can be brought into a disengaged state, in which a first actuation stroke of the actuating lever is an idle stroke with respect to the release lever, wherein the clutch arrangement can be transferred via the idle stroke into an engaged state, in which a second actuation stroke of the actuating lever adjusts the release lever to the release position for lifting the pawl.

### CROSS-REFERENCE TO RELATED APPLICATION

This application claims priority pursuant to 35 U.S.C. 119(a) to German Application No. 102024128990.2, filed Oct. 8, 2024, which application is incorporated herein by reference in its entirety.

### FIELD OF THE INVENTION

The present invention relates to a motor vehicle lock in accordance with the preamble of claim 1 and to a method for operating a motor vehicle lock according to the preamble of claim 15.

The motor vehicle lock in question is used for all types of locking elements of a motor vehicle. These include, in particular, locking elements such as side doors, rear doors, tailgates, trunk lids, hoods, and the like. These locking elements can generally be designed as swing or sliding doors.

### BACKGROUND

The known prior art (EP 2 799 648 A2), on which the invention is based, relates to a motor vehicle lock that has a lock latch and a pawl as locking elements. The lock latch can be brought into a locking position in which it is in holding engagement with a locking part and in which it is fixed by the pawl. The motor vehicle lock has an actuating lever which can be coupled to a door handle for manual actuation of the motor vehicle lock. The actuating lever is used to adjust a release lever for lifting the pawl.

The known motor vehicle lock is furthermore provided with a double-stroke function (two-stroke opening) for manual actuation, which is implemented by means of a clutch arrangement in the coupling of actuating lever and release lever. With the double-stroke function, a first actuation stroke of the actuating lever merely represents an idle stroke, but the clutch arrangement is transferred into an engaged state so that the pawl can be lifted with a subsequent, second actuation stroke and the motor vehicle lock can be opened. For activating the double-stroke function and for implementing further locking states, an adjustment drive is provided in the prior art.

A challenge in this respect is that the structure of the clutch arrangement and of the adjustment drive for implementing the double-stroke function is comparatively complex and requires additional installation space. The engagement of the double-stroke function must also be ensured by controlling the adjustment drive.

The invention is based on the problem of designing and developing the known motor vehicle lock in such a way that the double-stroke function for manual actuation is ensured in a simple manner.

### SUMMARY

The above problem is solved by the features of claim 1. The invention relates to a motor vehicle lock with a lock latch and at least one pawl for locking the lock latch, wherein the pawl is assigned a release lever, wherein an opening drive adjusts the release lever to the release position for lifting the pawl and subsequently returns the release lever to the initial position, wherein an actuating lever can be mechanically coupled to the release lever via a clutch arrangement, wherein the clutch arrangement can be brought into a disengaged state, in which a first actuation stroke of the actuating lever is an idle stroke with respect to the release lever, wherein the clutch arrangement can be transferred via the idle stroke into an engaged state, in which a second actuation stroke of the actuating lever adjusts the release lever to the release position for lifting the pawl. It is proposed that the electric opening drive brings the clutch arrangement into the disengaged state during the return movement of the release lever from the release position to the initial position.

The invention is based on the fact that the motor vehicle lock furthermore comprises an opening drive for electric motor actuation, which drive can also lift the pawl by means of the release lever. The key point to consider is that the motor-driven opening process carried out via the opening drive is used to bring the clutch arrangement into the disengaged state for the double-stroke function. In the event of a failure of the opening drive, the double-stroke function is thus reliably ensured for mechanical redundancy. In addition, an additional adjustment drive for influencing the clutch arrangement is not absolutely necessary, since the already existing opening drive activates the double-stroke function.

It is proposed that the electric opening drive brings the clutch arrangement into the disengaged state during the return movement of the release lever from the release position to the initial position.

In accordance with claim 2, the opening drive can preferably influence the clutch arrangement by adjusting the release lever so that the interaction between opening drive and clutch arrangement is achieved in a structurally simple manner.

Particularly preferably, the clutch arrangement is constructed with a clutch element that can be adjusted between an active position and a passive position for implementing the engaged or disengaged state (claim 3). Of particular interest here is an embodiment according to claims 5 and 6 with a control element spring-loading the clutch element, wherein the position of the clutch element can be controlled by switching the control element and the states of the clutch arrangement can thus be reliably implemented. Furthermore, in accordance with claims 9 and 10, the opening drive can act on the control element so that interaction with the opening drive is also brought about via the control element.

In the embodiment in accordance with claim 8, the clutch arrangement initially remains in the engaged state following the second actuation stroke, for example if the double-stroke function is used in the event of a failure of the opening drive. If the opening drive becomes available again later, it can reset the clutch arrangement during the return movement of the release lever.

The further embodiments in accordance with claims 11 to 14 relate to the use of a securing drive, which serves to additionally suppress the double-stroke function. In particularly preferred embodiments, the securing drive has a securing element with a securing contour, which can adjust the control element.

According to a further teaching in accordance with claim 15, which has independent significance, a method for operating a motor vehicle lock is claimed. It is essential that the electric opening drive brings the clutch arrangement into the disengaged state during the return movement of the release lever from the release position to the initial position. Reference may be made to all statements relating to the proposed motor vehicle lock.

### BRIEF DESCRIPTION OF THE DRAWINGS

In the following, the invention is explained in more detail with reference to a drawing that merely represents exemplary embodiments. In the drawings:

FIG. 1 shows a motor vehicle door with a), b), c) a proposed motor vehicle lock in perspective views;

FIG. 2 shows components for actuating the motor vehicle lock a) in a perspective view, b) in an exploded view;

FIG. 3 a) to f) show the components of FIG. 2 in side views during a first actuation stroke;

FIG. 4 a) to d) show the components of FIG. 2 in side views during a second actuation stroke;

FIG. 5 a) to d) show the components of FIG. 2 in side views when returning the release lever by means of the opening drive; and,

FIG. 6 a) to f) show the components of FIG. 2 in side views in the secured state.

### DETAILED DESCRIPTION OF THE INVENTION

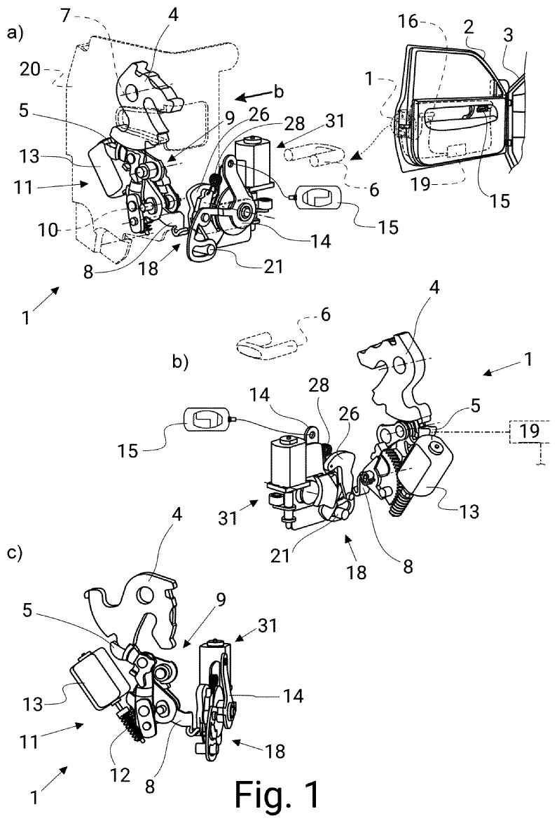

The exemplary embodiment shown in the figures and preferred in this respect relates to a motor vehicle lock 1 for a locking element 2 of a motor vehicle 3. Regarding the design of locking element 2, reference may be made to the introductory statements, wherein in the present case FIG. 1 shows the mode of operation of the motor vehicle lock 1 for locking element 2 designed as a side door. However, all embodiments also apply to all other types of locking elements 2 of the motor vehicle 3.

The motor vehicle lock 1 is equipped with a lock latch 4 and at least one pawl 5 for locking the lock latch 4. The lock latch 4 is adjustable to at least one locking position, here, and preferably, a main locking position, and optionally a pre-locking position, for holding engagement with a locking part 6 and to an open position (FIG. 1) for releasing the locking part 6, here, and preferably, by pivoting about a geometric lock latch axis 7. The locking part 6 may be a locking bracket, a locking bolt, or the like. In this embodiment, and preferably, the motor vehicle lock 1 is arranged on the locking element 2, while the locking part 6 is arranged fixed to the body of the motor vehicle 3, wherein a reverse arrangement is conceivable.

The pawl 5 interacting with the lock latch 4 can be brought into a catch state and a lifted state. In the catch state, pawl 5 locks the lock latch 4, which is in the locking position, against being adjusted in its opening direction. In the lifted state, pawl 5 releases the lock latch 4 in its opening direction so that the lock latch 4 can be transferred to the open position, for example by spring loading and/or by guiding out the locking part 6.

A release lever 8 is provided, which generally serves to transfer pawl 5 into the lifting state. The release lever 8 is assigned to pawl 5 in such a way that adjusting the release lever 8 from an initial position to a release position causes the pawl 5 to be lifted. The release lever 8 can act on the pawl 5 directly, for example via direct mechanical contact with the pawl 5, or indirectly, for example by means of at least one further component. In principle, multiple pawls 5 can also be provided. In the embodiment of FIG. 1, the pawl 5 is part of a pawl system 9, wherein the release lever 8 can transfer pawl system 9 into the lifted state during the adjustment to the release position.

Particularly preferably, the release lever 8 is provided to be pivotable about a geometric release lever axis 10. The initial position and the release position can correspond to respective rotational positions of the release lever 8 about the release lever axis 10.

An opening drive 11 for electric motor actuation is provided. In a motor-driven opening process, the opening drive 11 adjusts the release lever 8 to the release position to lift the pawl 5 and subsequently returns the release lever 8 to the initial position. Here, and preferably, the opening drive 11 has a gear 12, with which the drive movement of an electric drive motor 13 of the opening drive 11 is converted into the adjustment, in particular pivoting, of the release lever 8. In FIG. 1b), a gear 12 designed as a worm gear is shown in accordance with a preferred embodiment.

When the release lever 8 is adjusted via the opening drive 11, the pawl 5 is lifted and the motor vehicle lock 1 is thus actuated by an electric motor. Following the lifting of the pawl 5, it is provided that the opening drive 11 again returns the release lever 8 to the initial position. In this case, the opening drive 11, the gear 12, the release lever 8, and/or the pawl system 9 can be designed to be self-locking so that the release lever 8 initially maintains the lifted position without controlling the opening drive 11. The release lever 8 is preferably returned by reversing the opening drive 11, with which the release lever 8 is adjusted from the lifted position to the initial position opposite to the adjustment direction used for lifting. By returning the release lever 8, the pawl 5 can be released again by the release lever 8 to fall back into the catch state so that the motor vehicle lock 1 can be locked again.

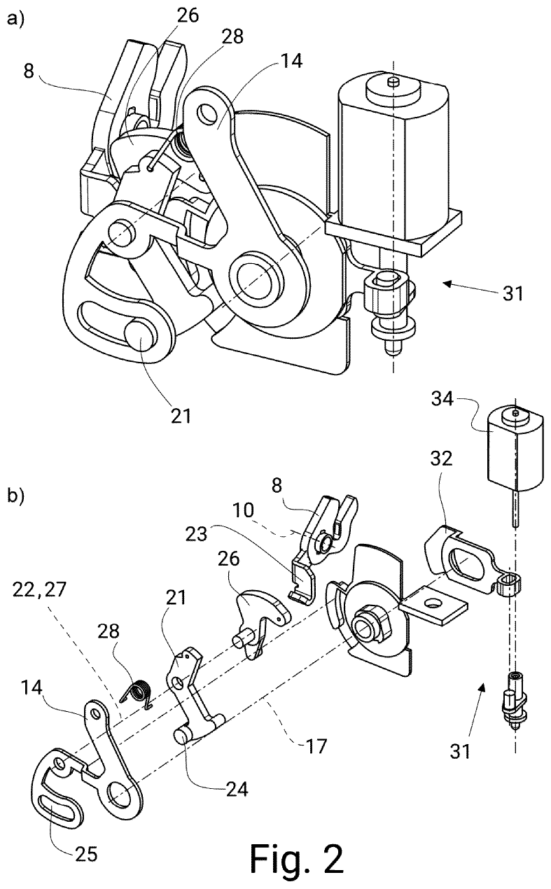

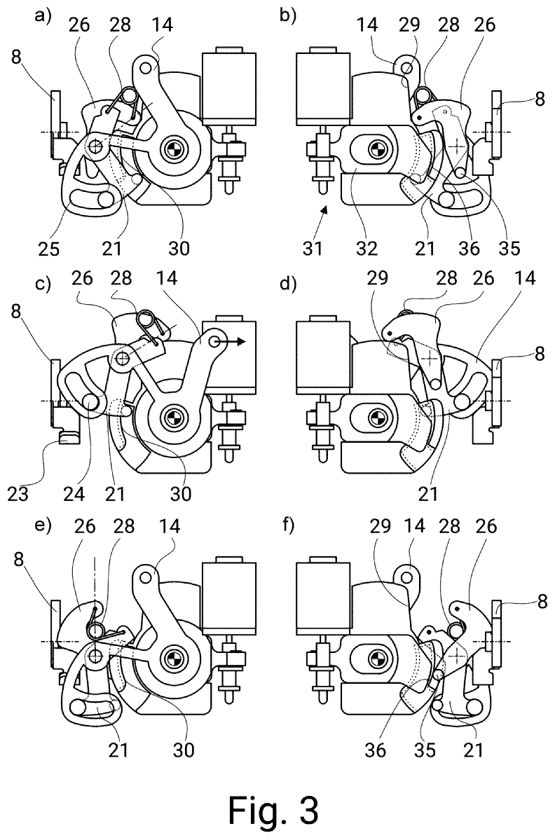

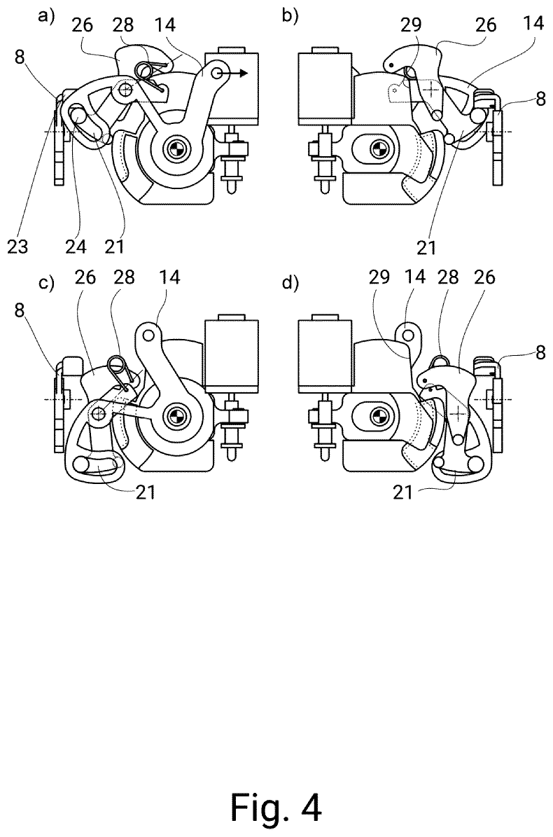

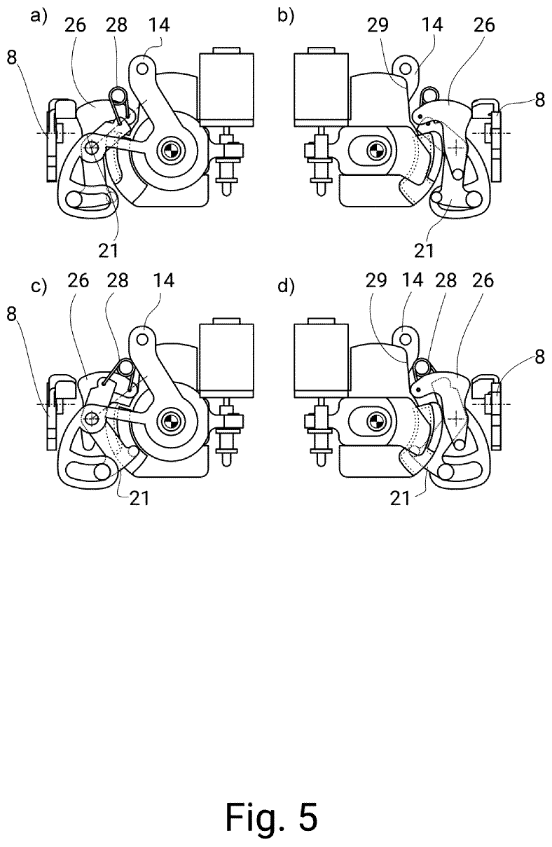

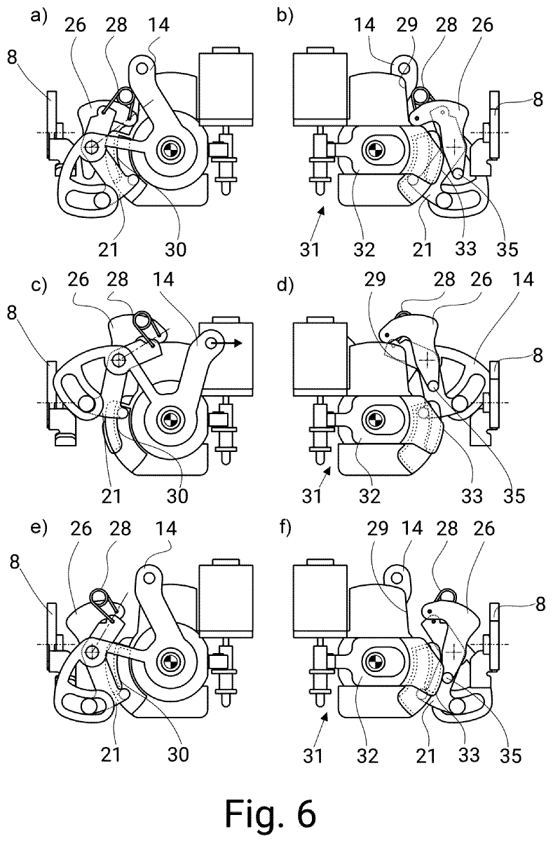

An actuating lever 14 for manual actuation is provided. The actuating lever 14 is provided here for coupling with an operating element such as a door handle. In the assembled state of the motor vehicle lock 1, the actuating lever 14 is mechanically connected, for example, to an interior door handle 15, to an exterior door handle 16 and/or to an emergency actuating element via a connecting element, such as a Bowden cable or a rod. An actuation force exerted manually on such an operating element can be transmitted to the actuating lever 14, whereby the actuating lever 14 executes an actuation stroke. During the actuation stroke, the actuating lever 14 is here, and preferably, manually pivotable about a geometric actuating lever axis 17 from an unactuated position (FIG. 3a), b), e), f); FIG. 4c), d); FIG. 5; FIG. 6a), b), e), f)) to an actuated position (FIG. 3c), d); FIG. 4a), b); FIG. 6c), d)). In the views in FIGS. 3 to 5, the actuating lever 14 is shown in side views for clarity, with a)-b); c)-d); e)-f) in each case showing the same positions in two opposite viewing directions. The actuating lever 14, the release lever 8 and components interacting therewith and yet to be explained are furthermore shown in FIG. 2a) in a perspective view and in FIG. 2b) in an exploded view.

The actuating lever 14 can be mechanically coupled to the release lever 8 via a clutch arrangement 18, wherein the release lever 8 can be manually adjusted from the initial position to the release position by means of the actuation stroke via the mechanical coupling. In a preferred embodiment, manual actuation is provided in addition to the electric motor actuation already described. For example, the opening drive 11 is also triggered via the actuation of the door handle, wherein the door handle is, for example, equipped with a sensor such as a button, which detects actuation of the door handle and triggers the opening drive 11. In the event of a failure of the opening drive 11, for example in the event of a lack of electrical power supply for the opening drive 11, the manual actuation of the motor vehicle lock 1 can be used, thus ensuring mechanical redundancy.

A double-stroke function is implemented via the clutch arrangement 18. The clutch arrangement 18 can be brought into a disengaged state (FIG. 3a) to d); FIG. 5c), d); FIG. 6) and into an engaged state (FIG. 3e), f); FIG. 4; FIG. 5a), b)). In the disengaged state, the clutch arrangement 18 prevents adjustment of the release lever 8 by means of the actuating lever 14. In the engaged state, however, the clutch arrangement 18 makes it possible to adjust the release lever 8 by means of the actuating lever 14. Here, in the disengaged state, a first actuation stroke of the actuating lever 14 is an idle stroke with respect to the release lever 8. Accordingly, with the first actuation stroke, the release lever 8 is not adjusted during the idle stroke, but the clutch arrangement 18 can be transferred into an engaged state via the idle stroke. An exemplary sequence of the first actuation stroke can be seen in FIG. 3.

In the engaged state, a second actuation stroke of the actuating lever 14 can adjust the release lever 8 to the release position for lifting the pawl 5. The second actuation stroke can be carried out chronologically after the first actuation stroke, which brought about the transfer into the engaged state. An exemplary sequence of the second actuation stroke can be seen in FIG. 3e), f) and FIG. 4. Accordingly, the motor vehicle lock 1 can be opened manually via the actuating lever 14. The terms “first” actuation stroke and “second” actuation stroke are chosen here to clarify the significance to the double-stroke function. In fact, the first actuation stroke and the second actuation stroke can be carried out in the same way with respect to the movement of the actuating lever 14, for example as a pivoting from the unactuated position to the actuated position in each case.

It is essential that the electric opening drive 11 brings the clutch arrangement 18 into the disengaged state during the return movement of the release lever 8 from the release position to the initial position.

Returning the release lever 8 via the opening drive 11 with the clutch arrangement 18 initially in the engaged state is shown in the sequence of FIG. 4c), d) and FIG. 5. In FIG. 4c), d), the clutch arrangement 18 is in the engaged state and the release lever 8 is in the release position after an actuation has already been carried out. The state of the motor vehicle lock 1 of FIG. 4c), d) can, as already described, be achieved via the double-stroke function during the second actuation stroke or also after the motor-driven adjustment of the release lever 8 by the opening drive 11. If the release lever 8 is returned via the opening drive 11, the clutch arrangement 18 is transferred into the disengaged state. FIG. 5a), b) show the beginning of the return movement of the release lever 8, with the clutch arrangement 18 still in the engaged state, wherein, during the continuation of the return movement according to FIG. 5c), d), a transfer to the disengaged position follows. With the completion of the return movement, the initial state in accordance with FIG. 3a), b) is reached again.

During normal operation of the motor vehicle lock 1, it can be provided that the opening drive 11 is triggered by actuating the actuating lever 14. The actuation stroke of the actuating lever 14 runs idle (cf. FIG. 3) so that no manual actuation is carried out, but the lifting of the pawl 5 takes place by an electric motor by adjusting the release lever 8 via the opening drive 11. Since, after the pawl 5 has been lifted, the release lever 8 is returned via the opening drive 11, which is accompanied by a transfer of the clutch arrangement 18 into the disengaged state, the double-stroke function remains reliably activated by returning the release lever 8. Accordingly, manual actuation can remain ineffective during normal operation.

The opening drive 11 can be controlled via a control arrangement 19, which is integrated, for example, in lock housing 20 of the motor vehicle lock 1 and/or, as shown in accordance with the view of FIG. 1, is implemented via a control unit external to the motor vehicle lock 1.

However, in the event of a failure of the opening drive 11, neither an actuation by electric motor nor a return movement of the release lever 8 via the opening drive 11 is carried out. Accordingly, the described double-stroke function takes effect since the clutch arrangement 18 is transferred into the engaged state after the first actuation stroke.

The transfer of the clutch arrangement 18 into the disengaged state by means of the opening drive 11 can be carried out in various ways. Here, and preferably, it is provided that the electric opening drive 11 brings the clutch arrangement 18 into the disengaged state by means of the adjustment of the release lever 8. The adjustment of the release lever 8 is therefore the cause for the transfer into the disengaged state. Preferably, the transfer into the disengaged state, as also shown in FIG. 5, is carried out via a mechanical contact between the release lever 8 and the clutch arrangement 18 during the return movement.

In general, it can be provided that the clutch arrangement 18 has a clutch element 21 which, in the engaged state, is in an active position, in which the clutch element 21 converts an actuation stroke of the actuating lever 14 into the adjustment of the release lever 8 to the release position, and which, in the disengaged state, is in a passive position, in which the clutch element 21 allows the actuation stroke to run idle. The clutch element 21 can therefore serve as a force converter between the actuating lever 14 and the release lever 8 in the active position but can allow idle running in the passive position, for example by the clutch element 21 in this case having no contact with the release lever 8 and/or the actuating lever 14.

Preferably the clutch element 21 is designed to be pivotable about a geometric clutch element axis 22. The active position and the passive position can in this case correspond to respective rotational positions of the clutch element 21 about the clutch element axis 22.

Furthermore, it is here, and preferably, provided that the clutch element 21 and the clutch arrangement 18 is arranged on the actuating lever 14. Here, and preferably, the clutch element axis 22 is defined on the actuating lever 14.

During the actuation stroke, a release element 23 of the release lever 8 is located in a movement range of the clutch element 21, which is in the active position, which can be seen in FIG. 4a), b). During the actuation stroke, the release element 23 is located outside a movement range of the clutch element 21, which is in the passive position, so that idle running and the idle stroke are implemented, which can be seen in the view in FIG. 3c), d). A driving element 24 of the clutch element 21, which can be brought into contact with the release element 23 depending on the presence of the active position, runs in this case in a recess 25 of the actuating lever 14, which recess furthermore serves as a movement limiter of the clutch element 21 and for defining the active position and the passive position.

It is preferably provided that the clutch arrangement 18 has a switchable control element 26, which adjusts the clutch element 21 between the active position and the passive position. Particularly preferably, the control element 26 is designed to be pivotable about a geometric control element axis 27. The switching positions of the control element 26 can in this case correspond to respective rotational positions about the control element axis 27. The control element axis 27 can be defined on the actuating lever 14. Here, and preferably, the control element 26 and the clutch element 21 are mounted concentrically.

The control element 26 and the clutch element 21 are mechanically coupled in order to allow the clutch element 21 to be adjusted by switching the control element 26. It is preferably provided that the control element 26 causes a spring load of the clutch element 21 in the direction of the active position in a first switching position and causes a spring load of the clutch element 21 in the direction of the passive position in a second switching position.

The spring load is brought about here, and preferably, via a toggle spring 28. The toggle spring 28 is provided between the control element 26 and the clutch element 21 for adjusting the clutch element 21 via the control element 26. In this case, the toggle spring 28 spring-loads the clutch element 21 against the control element 26 in the direction of the active position in the first switching position and spring-loads it against the control element 26 in the direction of the passive position in the second switching position.

The position of the clutch element 21 can be controlled accordingly via the control element 26 by switching the control element 26 during the actuation stroke, during the first actuation stroke. Furthermore, a control contour 29 is here, and preferably, provided, which adjusts the control element 26 in the disengaged state from the first switching position to the second switching position upon completion of the first actuation stroke. The control contour 29 is here, and preferably, designed to be immovable relative to the actuating lever 14 and is provided, for example, on a housing element of the motor vehicle lock 1. Via the (first) actuation stroke, the control element 26 is brought into mechanical contact with the control contour 29 or guided along the control contour 29, which can be seen in the view in FIG. 3c), d), whereby the control element 26 is adjusted to the second switching position. The spring load of the clutch element 21 via the toggle spring 28, which in the initial state of FIG. 3a), b) acts in the direction of the passive position, is reversed here by switching and is now carried out in the direction of the active position.

Preferably, however, after the adjustment of the control element 26 to the second switching position, the clutch element 21 remains in the passive position, in particular via contact with a guide contour 30, for a portion of the return movement of the actuating lever 14 from the actuation stroke. Only when the return movement is completed does the guide contour 30 release the clutch element 21 to move to the active position in accordance with the spring load (FIG. 3e), f)). The guide contour 30 is here, and preferably, immovable relative to the actuating lever 14 and can be provided on the housing element. In particular, the passive position is maintained in such a way that, when the actuating lever 14 is returned from the actuation stroke, the clutch element 21 remains without contact with the release element 23 so that jamming of the clutch element 21 and the release lever 8 is reliably prevented.

In general, it is preferably provided that the clutch arrangement 18, which in the engaged state, remains in the engaged state following the actuation stroke until it is transferred into the disengaged state by means of the electric opening drive 11. This makes it possible for the manual actuation to be effective in the event of a failure of the opening drive 11. If the opening drive 11 is available again, the clutch arrangement 18 can be reset into the disengaged state by returning the release lever 8.

Furthermore, it is here, and preferably, provided that, when the actuating lever 14 is returned from the actuation stroke, the control element 26, which is in the second switching position, remains without contact with the release lever 8, which is in the release position. Here, the control element 26, which is in the second switching position, runs past the release element 23 (in FIG. 4a) and in FIG. 4c), the control element 26 is located, in the viewing direction there, in front of the release element 23 in such a way that no contact occurs). Only when the release lever 8 is returned does contact occur between the release element 23 and the control element 26 (FIG. 5a), b)) since the release element 23 is brought into the movement range of the control element 26 when the release lever 8 is pivoted.

Accordingly, in a preferred embodiment, it is provided that the control element 26, which is in the second switching position, can be adjusted into the first switching position by means of the electric opening drive 11 during the return movement of the release lever 8, via contact between the release element 23 and the control element 26. From the contact between the release element 23 and the control element 26 in FIG. 5a), b), a change in the spring load of the toggle spring 28 is carried out while switching the control element 26 into the first switching position in accordance with FIG. 5c), d).

In a further embodiment, a securing drive 31 is provided for the clutch arrangement 18, which securing drive, in a secured state, suppresses a transfer of the clutch arrangement 18 into the engaged state and, in an unsecured state, releases a transfer of the clutch arrangement 18 into the engaged state.

The suppression of the transfer of the clutch arrangement 18 into the engaged state is to be understood broadly here. In the secured state, the securing drive 31 can generally prevent the clutch arrangement 18 from being transferred into the engaged state or can transfer the clutch arrangement 18, which is already in the engaged state, into the disengaged state.

It is particularly preferably provided that the securing drive 31 adjusts a securing element 32 which, in the secured state, suppresses an adjustment of the control element 26 to the second switching position via a securing contour 33. The secured state is shown in FIG. 6. In the unsecured state, the securing element 32 can release an adjustment of control element 26 to the second switching position, which is shown in FIGS. 3 to 5. It is particularly preferably provided that the securing drive 31 linearly adjusts the securing element 32 relative to the actuating lever 14 upon transition between the unsecured state and the secured state. Here, and preferably, the securing drive 31 has a securing motor 34, the rotational movement of which is converted into the linear movement of the securing element 32.

In the disengaged state, the control contour 29 can initially adjust the control element 26 from the first switching position to the second switching position upon completion of the actuation stroke, which is shown in FIG. 6a) to FIG. 6d) and here, and preferably, corresponds to the mode of operation of the control contour 29 and control element 26 previously explained for the unsecured state. It is furthermore provided that, in the secured state, the securing drive 31 adjusts the control element 26 from the second switching position to the first switching position when the actuating lever 14 is returned from the actuation stroke. In the view in FIG. 6e), f), the control element 26 is switched via contact with the securing contour 33. In the process, the direction of the spring load on the clutch element 21 via the toggle spring 28 is reversed so that the state in FIG. 6a), b) with the disengaged state of the clutch arrangement 18 is subsequently resumed. Accordingly, manual actuation remains ineffective in the secured state.

Furthermore, it is here, and preferably, provided that the control element 26 has a stop 35 which, in the second switching position, rests against a stop contour 36 in a spring-loaded manner (FIG. 3f)), and that the securing contour 33 suppresses an adjustment of the control element 26 to the second switching position via the stop 35 (FIG. 6f)).

In accordance with a further teaching, a method is proposed for operating a motor vehicle lock 1 with a lock latch 4 and at least one pawl 5 for locking the lock latch 4, wherein the pawl 5 is assigned a release lever 8 in such a way that an adjustment of the release lever 8 from an initial position to a release position causes the pawl 5 to be lifted, wherein an opening drive 11 for electric motor actuation is provided, wherein, in a motor-driven opening process, the opening drive 11 adjusts the release lever 8 to the release position for lifting the pawl 5 and subsequently returns the release lever 8 to the initial position, wherein an actuating lever 14 for manual actuation is provided, which actuating lever can be mechanically coupled to the release lever 8 via a clutch arrangement 18, wherein the clutch arrangement 18 can be brought into a disengaged state, in which a first actuation stroke of the actuating lever 14 is an idle stroke with respect to the release lever 8, wherein the clutch arrangement 18 can be transferred via the idle stroke into an engaged state, in which a second actuation stroke of the actuating lever 14 adjusts the release lever 8 to the release position for lifting the pawl 5.

It is provided that the electric opening drive 11 brings the clutch arrangement 18 into the disengaged state during the return movement of the release lever 8 from the release position to the initial position. Reference may be made to all statements relating to the proposed motor vehicle lock 1.

1. A motor vehicle lock with a lock latch and at least one pawl for locking the lock latch, wherein the pawl is assigned a release lever in such a way that an adjustment of the release lever from an initial position to a release position causes the pawl to be lifted, wherein an opening drive for electric motor actuation is provided, wherein, in a motor-driven opening process, the opening drive adjusts the release lever to the release position for lifting the pawl and subsequently returns the release lever to the initial position, wherein an actuating lever for manual actuation is provided, which actuating lever can be mechanically coupled to the release lever via a clutch arrangement, wherein the clutch arrangement can be brought into a disengaged state, in which a first actuation stroke of the actuating lever is an idle stroke with respect to the release lever, wherein the clutch arrangement can be transferred via the idle stroke into an engaged state, in which a second actuation stroke of the actuating lever adjusts the release lever to the release position for lifting the pawl, wherein the electric opening drive brings the clutch arrangement into the disengaged state during the return movement of the release lever from the release position to the initial position.

2. The motor vehicle lock according to claim 1, wherein the electric opening drive brings the clutch arrangement into the disengaged state by means of the adjustment of the release lever.

3. The motor vehicle lock according to claim 1, wherein the clutch arrangement has a clutch element which, in the engaged state, is in an active position, in which the clutch element converts an actuation stroke of the actuating lever into the adjustment of the release lever to the release position, and which, in the disengaged state, is in a passive position, in which the clutch element allows the actuation stroke to run idle.

4. The motor vehicle lock according to claim 3, wherein the clutch element, in particular the clutch arrangement, is arranged on the actuating lever, in that, during the actuation stroke, a release element of the release lever is located in a movement range of the clutch element, which is in the active position, and in that, during the actuation stroke, the release element is located outside a movement range of the clutch element, which is in the passive position.

5. The motor vehicle lock according to claim 3, wherein the clutch arrangement has a switchable control element, which adjusts the clutch element between the active position and the passive position, preferably in that the control element causes a spring load of the clutch element in the direction of the active position in a first switching position and causes a spring load of the clutch element in the direction of the passive position in a second switching position.

6. The motor vehicle lock according to claim 5, wherein a toggle spring is provided between the control element and the clutch element for adjusting the clutch element via the control element, preferably in that the toggle spring spring-loads the clutch element against the control element in the direction of the active position in the first switching position and spring-loads it against the control element in the direction of the passive position in the second switching position.

7. The motor vehicle lock according to claim 5, wherein a control contour is provided, which, in the disengaged state, adjusts the control element from the first switching position to the second switching position upon completion of the actuation stroke, preferably in that, after the adjustment of the control element to the second switching position, the clutch element remains in the passive position, in particular via contact with a guide contour, for a portion of the return movement of the actuating lever from the actuation stroke, in particular in such a way that the clutch element remains without contact with the release element when the actuating lever is returned from the actuation stroke.

8. The motor vehicle lock according to claim 1, wherein the clutch arrangement, which is in the engaged state, remains in the engaged state following the second actuation stroke until a transfer into the disengaged state is carried out by means of the electric opening drive.

9. The motor vehicle lock according to claim 5, wherein, when the actuating lever is returned from the actuation stroke, the control element, which is in the second switching position, remains without contact with the release lever, which is in the release position.

10. The motor vehicle lock according to claim 5, wherein the control element, which is in the second switching position, can be adjusted into the first switching position by means of the electric opening drive during the return movement of the release lever, in particular via a contact between the release element and the control element.

11. The motor vehicle lock according to claim 1, wherein a securing drive is provided for the clutch arrangement, which securing drive, in a secured state, suppresses a transfer of the clutch arrangement into the engaged state and, in an unsecured state, releases a transfer of the clutch arrangement into the engaged state.

12. The motor vehicle lock according to claim 11, wherein the securing drive adjusts a securing element which, in the secured state, suppresses an adjustment of the control element to the second switching position via a securing contour, and which, in the unsecured state, releases an adjustment of the control element to the second switching position, preferably in that the securing drive linearly adjusts the securing element relative to the actuating lever upon transition between the unsecured state and the secured state.

13. The motor vehicle lock according to claim 11, wherein in the disengaged state, the control contour adjusts the control element from the first switching position to the second switching position upon completion of the actuation stroke, and in that, in the secured state, the securing drive adjusts the control element from the second switching position to the first switching position when the actuating lever is returned from the actuation stroke.

14. The motor vehicle lock according to claim 12, wherein the control element has a stop which, in the second switching position, rests against a stop contour in a spring-loaded manner, and in that the securing contour suppresses an adjustment of the control element to the second switching position via the stop.

15. A method for operating a motor vehicle lock with a lock latch and at least one pawl for locking the lock latch, wherein the pawl is assigned a release lever in such a way that an adjustment of the release lever from an initial position to a release position causes the pawl to be lifted, wherein an opening drive for electric motor actuation is provided, wherein, in a motor-driven opening process, the opening drive adjusts the release lever to the release position for lifting the pawl and subsequently returns the release lever to the initial position, wherein an actuating lever for manual actuation is provided, which actuating lever can be mechanically coupled to the release lever via a clutch arrangement, wherein the clutch arrangement can be brought into a disengaged state, in which a first actuation stroke of the actuating lever is an idle stroke with respect to the release lever, wherein the clutch arrangement can be transferred via the idle stroke into an engaged state, in which a second actuation stroke of the actuating lever adjusts the release lever to the release position for lifting the pawl, wherein the electric opening drive brings the clutch arrangement into the disengaged state during the return movement of the release lever from the release position to the initial position.

16. The motor vehicle lock according to claim 2, wherein the clutch arrangement has a clutch element which, in the engaged state, is in an active position, in which the clutch element converts an actuation stroke of the actuating lever into the adjustment of the release lever to the release position, and which, in the disengaged state, is in a passive position, in which the clutch element allows the actuation stroke to run idle.

17. The motor vehicle lock according to claim 13, wherein the control element has a stop which, in the second switching position, rests against a stop contour in a spring-loaded manner, and in that the securing contour suppresses an adjustment of the control element to the second switching position via the stop.

18. The motor vehicle lock according to claim 12, wherein in the disengaged state, the control contour adjusts the control element from the first switching position to the second switching position upon completion of the actuation stroke, and in that, in the secured state, the securing drive adjusts the control element from the second switching position to the first switching position when the actuating lever is returned from the actuation stroke.

19. The motor vehicle lock according to claim 6, wherein a control contour is provided, which, in the disengaged state, adjusts the control element from the first switching position to the second switching position upon completion of the actuation stroke, preferably in that, after the adjustment of the control element to the second switching position, the clutch element remains in the passive position, in particular via contact with a guide contour, for a portion of the return movement of the actuating lever from the actuation stroke, in particular in such a way that the clutch element remains without contact with the release element when the actuating lever is returned from the actuation stroke.

20. The motor vehicle lock according to claim 4, wherein the clutch arrangement has a switchable control element, which adjusts the clutch element between the active position and the passive position, preferably in that the control element causes a spring load of the clutch element in the direction of the active position in a first switching position and causes a spring load of the clutch element in the direction of the passive position in a second switching position.
